(19) United States
(12) Patent Application Publication
(10) Pub. No.: US 2026/0180312 A1
(43) Pub. Date: Jun. 25, 2026

(54) POWER CIRCUIT AND DISPLAY DEVICE INCLUDING THE SAME

(71) Applicant: LG Display Co., Ltd., Seoul (KR)

(72) Inventors: Jae Won HAN, Paju-si (KR); Ki Yol CHONG, Paju-si (KR); Geun Woo KOH, Paju-si (KR)

(73) Assignee: LG Display Co., Ltd., Seoul (KR)

(21) Appl. No.: 19/345,359

(22) Filed: Sep. 30, 2025

(30) Foreign Application Priority Data
Dec. 23, 2024 (KR) 10-2024-0193637

(51) Int. Cl. H02H 7/12; G09G 3/20

(52) U.S. Cl. CPC H02H 7/1213; G09G 3/2014; G09G 2330/04

(57) ABSTRACT

A power circuit and a display device including the same are disclosed. The power circuit includes: a first node to which an input voltage is applied; an inductor connected between the first node and a second node; a third node from which an output voltage is output; a diode connected between the second node and the third node; a transistor connected between the second node and a fourth node and configured to generate a switching current according to a gate voltage; and a controller connected to the fourth node and configured to stop driving of the transistor and output an alarm signal in response to an overcurrent protection voltage proportional to the switching current.

### CROSS-REFERENCE TO RELATED APPLICATION

This application claims priority to and the benefit of Korean Patent Application No. 10-2024-0193637, filed Dec. 23, 2024, the disclosure of which is incorporated herein by reference in its entirety.

### BACKGROUND

### Technical Field

The present disclosure relates to a power circuit and a display device including the same.

### Description of the Related Art

A power circuit that outputs a constant voltage (or direct current (DC) voltage) is required to drive the driving circuit of a display device. The power circuit may support over current protection (hereinafter referred to as “OCP”).

The display device may support various driving modes such as a low power consumption mode and a high luminance mode. The required input voltage and output voltage of the power circuit may vary depending on the driving mode of the display device. The input voltage and output voltage of the power circuit may vary depending on the size and resolution of the display panel.

When the input voltage or output voltage of the power circuit is changed, the output current and the OCP target level of the power circuit may be mis-matched. In this case, a normal output current may be misrecognized as an overcurrent, causing the power circuit and the display panel driving circuit of the display device to malfunction or shut down in a normal driving situation.

The description provided in the discussion of the related art section should not be assumed to be prior art merely because it is mentioned in or associated with that section. The discussion of the related art section may include information that describes one or more aspects of the subject technology, and the description in this section does not limit the present disclosure.

### BRIEF SUMMARY

The present disclosure improves, among other, the over current protection “OCP” mechanism of a display device.

The present disclosure provides a power circuit capable of accurately controlling OCP and a display device including the same.

The features of the present disclosure are not limited to those mentioned herein, and other features or characteristics not specifically mentioned will be clearly understood by those skilled in the art from the description below.

A power circuit according to an embodiment of the present disclosure includes: a first node to which an input voltage is applied; an inductor connected between the first node and a second node; a third node from which an output voltage is output; a diode connected between the second node and the third node; a transistor connected between the second node and a fourth node and configured to generate a switching current according to a gate voltage; and a controller connected to the fourth node and configured to stop driving of the transistor and output an alarm signal in response to an overcurrent protection voltage proportional to the switching current.

The power circuit may further include a resistor connected between the fourth node and a ground voltage node.

The controller may include: a first sensing part configured to sense a feedback output voltage from the third node; a PWM control part configured to adjust a duty ratio of the gate voltage when the feedback output voltage fluctuates; a second sensing part configured to generate the overcurrent protection voltage based on at least one of the input voltage and the output voltage and to output an alarm voltage when the voltage of the fourth node becomes higher than the overcurrent protection voltage; and an OCP control part configured to output the alarm signal in response to the alarm voltage and to stop outputting the gate voltage from the PWM control part.

When the input voltage increases, the switching current and the overcurrent protection voltage may decrease.

A first reference voltage and a second reference voltage may be generated as constant voltages at different voltage levels. The first reference voltage may be set as a highest voltage within an adjustable range of the input voltage. The second reference voltage may be set as a lowest voltage within an adjustable range of the overcurrent protection voltage.

The second sensing part may include a subtractor configured to amplify a difference voltage between the input voltage and the first reference voltage; an adder configured to add the second reference voltage to an output voltage of the subtractor to output the overcurrent protection voltage; and a comparator configured to output the alarm voltage when the voltage of the fourth node is higher than the overcurrent protection voltage.

When the output voltage increases, the switching current and the overcurrent protection voltage may increase.

A first reference voltage and a second reference voltage second sensing part be generated as constant voltages at different voltage levels. The first reference voltage may be set as a lowest voltage within an adjustable range of the output voltage. The second reference voltage may be set as a lowest voltage within an adjustable range of the overcurrent protection voltage.

The second sensing part may include: a subtractor configured to amplify a difference voltage between the feedback output voltage and the first reference voltage; an adder configured to add the second reference voltage to an output voltage of the subtractor to output the overcurrent protection voltage; and a comparator configured to output the alarm voltage when the voltage of the fourth node is higher than the overcurrent protection voltage.

When a difference between the input voltage and the output voltage increases, the switching current and the overcurrent protection voltage may increase.

A reference voltage may be generated. The reference voltage may be set as a lowest voltage within an adjustable range of the overcurrent protection voltage.

The second sensing part may include: a subtractor configured to amplify a difference voltage between the input voltage and the feedback output voltage; an adder configured to add the reference voltage to an output voltage of the subtractor to output the overcurrent protection voltage; and a comparator configured to output the alarm voltage when the voltage of the fourth node is higher than the overcurrent protection voltage.

A display device according to an embodiment of the present disclosure includes: a display panel having a plurality of data lines, a plurality of gate lines, and a plurality of pixels disposed thereon; a display panel driving circuit configured to write data to the pixels; and the power circuit described above.

The present disclosure may not only reduce the power consumption of the display device but also optimize OCP control by adjusting the OCP level to an optimal value when at least one of the input voltage and the output voltage of the power circuit changes, even when the difference between the input voltage and the output voltage changes. As a result, the present disclosure may prevent or reduce the problem of the power circuit and the display panel driving circuit of the display device from malfunctioning or shutting down due to OCP malfunction in a normal driving situation even when the difference between the input voltage and the output voltage changes.

The present disclosure may support various driving modes of the display device by controlling the OCP level to an optimal value even when the difference between the input voltage and the output voltage of the power circuit changes, and may compatibly apply the power circuit to display panels with different sizes and resolutions.

The effects of the present disclosure are not limited to the effects mentioned above, and other effects not mentioned will be clearly understood by those skilled in the art from the description of the claims.

Other systems, methods, features and advantages will be, or will become, apparent to one with skill in the art upon examination of the following figures and detailed description. It is intended that all such additional systems, methods, features and advantages be included within this description, and be within the scope of the present disclosure, and be protected by the following claims. Nothing in this section should be taken as a limitation on those claims. Further aspects and advantages are discussed below in conjunction with embodiments of the disclosure.

It is to be understood that both the foregoing general description and the following detailed description are exemplary and explanatory and are intended to provide further explanation of the inventive concepts as claimed.

### BRIEF DESCRIPTION OF THE SEVERAL VIEWS OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram showing a display device according to an embodiment of the present disclosure;

FIG. 2 is a circuit diagram showing a power circuit according to an embodiment of the present disclosure;

FIGS. 3A to 3C are diagrams showing an example in which the switching current changes when the input voltage changes in the circuit shown in FIG. 2 according to an embodiment of the present disclosure;

FIGS. 4A to 4C are diagrams showing an example in which the switching current changes when the output voltage changes in the circuit shown in FIG. 2 according to an embodiment of the present disclosure;

FIG. 5 is a block diagram schematically showing the configuration of the controller shown in FIG. 2 according to an embodiment of the present disclosure;

FIG. 6 is a diagram showing an example in which the OCP voltage level is adjusted when the input voltage changes according to an embodiment of the present disclosure;

FIG. 7 is a circuit diagram showing a second sensing part according to an embodiment of the present disclosure;

FIG. 8 is a diagram showing an example in which the OCP voltage level is adjusted when the output voltage changes according to an embodiment of the present disclosure;

FIG. 9 is a circuit diagram showing a power circuit according to another embodiment of the present disclosure;

FIG. 10 is a circuit diagram showing a second sensing part applicable to the power circuit shown in FIG. 9 according to another embodiment of the present disclosure;

FIG. 11 is a diagram showing an example in which the OCP voltage level is adjusted when the input voltage and the output voltage change according to another embodiment of the present disclosure; and

FIG. 12 is a circuit diagram showing the circuit configuration of a second sensing part for controlling OCP based on the difference between the input voltage and the output voltage according to another embodiment of the present disclosure.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

Reference will now be made in detail to embodiments of the present disclosure, examples of which may be illustrated in the accompanying drawings. In the following description, when a detailed description of well-known functions or configurations related to this document is determined to unnecessarily cloud a gist of the inventive concept, the detailed description thereof will be omitted or may be briefly discussed. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations may be selected only for convenience of writing the specification and may be thus different from those used in actual products.

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

Any implementation described herein as an “example” is not necessarily to be construed as preferred or advantageous over other implementations.

The terms such as “comprising,” “including,” “having,” and “consist of” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after”, “following”, “next to”, “before”, or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

Also, when an element or layer is “connected,” “coupled,” or “adhered” to another element or layer denotes that the element or layer can not only be directly connected or adhered to another the other element or layer, but also be indirectly connected or adhered to another the other element or layer with one or more intervening elements or layers “disposed,” or “interposed” between the elements or layers, unless otherwise specified. It should be understood to mean that elements may be so disposed to directly contact each other, or may be so disposed without directly contacting each other.

The expression of a first element, a second elements “and/or” a third element should be understood as one of the first, second and third elements or as any or all combinations of the first, second and third elements. By way of example, A, B and/or C can refer to only A; only B; only C; any or some combination of A, B, and C; or all of A, B, and C.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

Rather, these embodiments may be provided so that this disclosure may be sufficiently thorough and complete to assist those skilled in the art to fully understand the scope of the present disclosure. Furthermore, the present disclosure is only defined by scopes of claims.

The following embodiments can be partially or entirely bonded to or combined with each other and can be linked and operated in technically various ways. The embodiments can be carried out independently of or in association with each other.

Hereinafter, embodiments of the present disclosure will be described in detail with reference to the accompanying drawings.

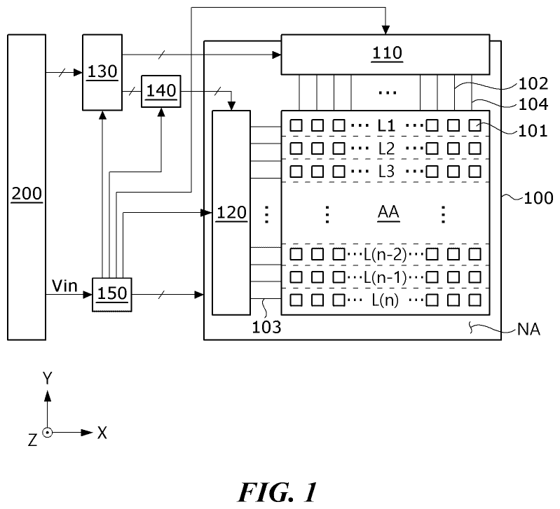

FIG. 1 is a block diagram illustrating a display device according to one embodiment of the present disclosure.

Referring to FIG. 1, the display device according to an embodiment of the present disclosure includes a display panel 100 and a display panel driving circuit for writing pixel data to pixels of the display panel 100.

The display panel 100 may be a panel having a rectangular structure with a length (or width) in the X-axis direction, a length in the Y-axis direction, and a thickness in the Z-axis direction. The X-axis direction may be either a first direction or a left and right direction. The Y-axis direction may be a second direction intersecting the first direction, or an up and down direction. A display area AA of the display panel 100 includes a pixel array for displaying an input image thereon. The pixel array includes a plurality of data lines 102, a plurality of gate lines 103 intersecting the data lines 102, and a plurality of pixels 101 arranged in a matrix form. The display panel 100 may further include power lines commonly connected to the pixels 101. The power lines may be commonly connected to the pixels 101 and supply a constant voltage required for driving the pixels 101 to the pixels 101.

Each of the pixels 101 may be divided into a red (R) sub-pixel, a green (G) sub-pixel, and a blue (B) sub-pixel for color implementation. Each of the pixels may further include a white (W) sub-pixel. In the following, a pixel may be interpreted as a sub-pixel. Each of the sub-pixels includes a pixel circuit.

A pixel circuit of a liquid crystal display device may apply a data voltage, the voltage level of which varies according to a grayscale value of pixel data, to the pixel electrode, and drive liquid crystal molecules of a liquid crystal cell between the pixel electrode and a common electrode, thereby varying the transmittance of the display panel according to the grayscale value of the pixel data. A pixel circuit of an electroluminescent display device supplies a current that varies according to a grayscale value of pixel data to a light-emitting element disposed in each sub-pixel to turn on the light-emitting element with brightness corresponding to the grayscale value of the pixel data. The light-emitting element may be, but not limited to, an organic light-emitting diode (OLED) or a micro light-emitting diode (LED).

The display area AA includes a plurality of pixel lines L1 to Ln. Each of the pixel lines L1 to L(n) includes 1 (one) line of sub-pixels arranged along the X-axis direction in the display area AA. The sub-pixels arranged on one pixel line may share a gate line 103. One horizontal period is a time obtained by dividing one frame period by the total number of the pixel lines L1 to L(n). The sub-pixels arranged along the Y-axis direction may share a data line 102.

Touch sensors may be arranged on the display panel 100 to sense touch inputs. The touch sensors may be arranged as an on-cell type or an add-on type on the display panel 100 or implemented as in-cell type touch sensors embedded in the pixel array.

The data lines 102 are arranged in the form of long wires along the Y-axis direction of the display panel 100 and are electrically connected to data channels of a data driver 110. The gate lines 103 are arranged in the form of long wires along the X-axis direction of the display panel 100 to intersect the data lines 102 and are electrically connected to output nodes (or terminals) of the gate driver 120.

The display panel driving circuit writes the pixel data of the input image to the pixels 101 in the display panel 100 under the control of a timing controller 130. The display panel driving circuit includes the data driver 110 and the gate driver 120.

The data driver 110 receives the pixel data of the input image from the timing controller 130 and outputs the data voltage. The data voltage is supplied to the data lines 102. The data channels of the data driver converts pixel data of the input image into a gamma compensation voltage using a digital-to-analog hereinafter referred to as “DAC”) and output the data voltage of the pixel data. A gamma reference voltage is divided through a voltage divider circuit into a gamma compensation voltage for each grayscale. The gamma compensation voltage for each grayscale is provided to the DAC of the data driver 110. The data voltage may be output through output buffers from the respective data channels of the data driver 110 and then supplied to the data lines 102.

The gate driver 120 may be arranged in a non-display area NA on at least one of the right or left sides outside the display area AA in the display panel 100, or at least a portion thereof may be arranged within the display area AA. The gate driver 120 may be located in the non-display areas NA on both sides of the display panel 100 with the display area AA of the display panel 100 interposed therebetween, and may supply pulses of the gate signals from the both ends of the gate lines 103 in a double feeding method. In another embodiment, the gate driver 120 may be located in at least one side of the left and right non-display areas of the display panel 100 to supply a gate signal to the gate lines 103 in a single feeding method. The gate driver 120 sequentially outputs pulses of the gate signals to the gate lines 103 under the control of the timing controller 130. The gate driver 120 may sequentially supply the pulses of the gate signals to the gate lines 103 by shifting the pulses of the gate signals using shift registers. The gate signals may include scan signals.

A host system 200 may scale an image signal from a video source to match the resolution of the display panel 100, and may transmit it to the timing controller 130 together with the timing control signal. The timing controller 130 receives digital video data of the input image and a timing signal synchronized with the digital video data from the host system 200. The timing signal may include a vertical synchronization signal Vsync, a horizontal synchronization signal Hsync, and a data enable signal DE. Since a vertical period and a horizontal period may be known by counting the data enable signal DE, the vertical synchronization signal Vsync and the horizontal synchronization signal Hsync may be omitted. The data enable signal DE defines the valid interval of pixel data, including the pulses that are generated during the active period every frame period. The horizontal synchronization signal Hsync and the data enable signal DE have a period of one horizontal period (1H).

The timing controller 130 may control the operation timing of each of the data driver 110 and the gate driver 120 based on the timing signals Vsync, Hsync, and DE received from a host system 200. The first controller 130 generates a data timing control signal for controlling the operation timing of the data driver 110 and a gate timing control signal for controlling the operation timing of the gate driver 120.

The display panel driving circuit further includes a level shifter 140 and a power circuit 150.

The level shifter 140 may level-shift the voltage of the input signal, such as the gate timing control signal, received from the timing controller 130, to output the output signal at a voltage higher than the input signal. For example, the input signal of the level shifter 140 may be a signal of digital signal voltage level, and the output signal from the level shifter 140 may be an analog voltage signal that swings between a gate high voltage and a gate low voltage. The gate timing control signal output from the level shifter 140 may be input to the gate driver 120. The gate timing control signal may include a start pulse and clock. The gate timing control signal may further include a gate output enable signal.

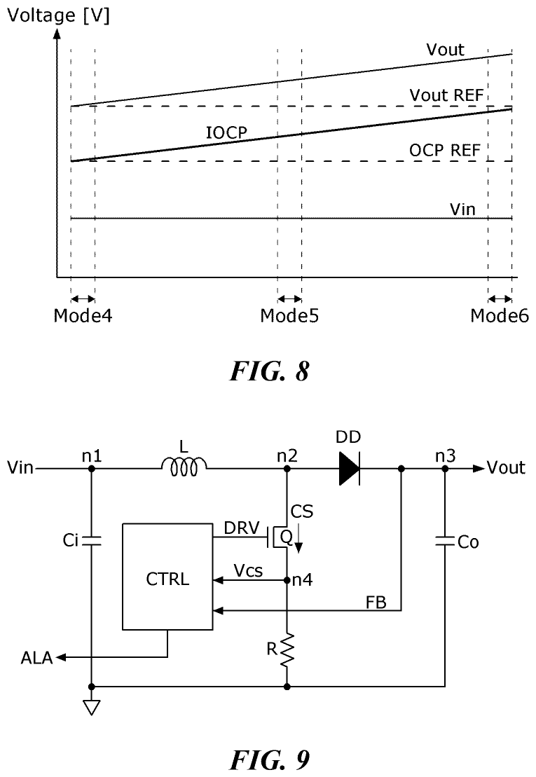

The power circuit 150 may include, but is not limited to, a charge pump, a regulator, a buck converter, a boost converter, and the like. The power supply 150 may receive a direct current (DC) input voltage from the host system 200 and generate the power required to drive the display panel driving circuits 110 and 120 and the pixels 101. The power circuit 150 may output the gamma reference voltage, the gate high voltage, the gate low voltage, and a constant voltage (or DC voltage) necessary for driving the pixel circuit. The gamma reference voltage may be supplied to the DAC of the data driver 110. The gate high voltage and the gate low voltage may be supplied to the level shifter 140 and the gate driver 120. The constant voltage necessary for driving the pixel circuit may include, for example, but is not limited to, the common voltage of a liquid crystal display, the pixel driving voltage of an electroluminescent display, the pixel ground voltage, the reference voltage, and the like. The power circuit 150 generates the reference voltages, Vin Ref, Vout Ref, and OCP REF, shown in FIG. 5, FIG. 8, and FIG. 11. The power circuit 150 may adjust the level of the output voltage under the control of the timing controller 130. The power circuit 150 may be implemented as a power management integrated circuit (PMIC), but is not limited thereto.

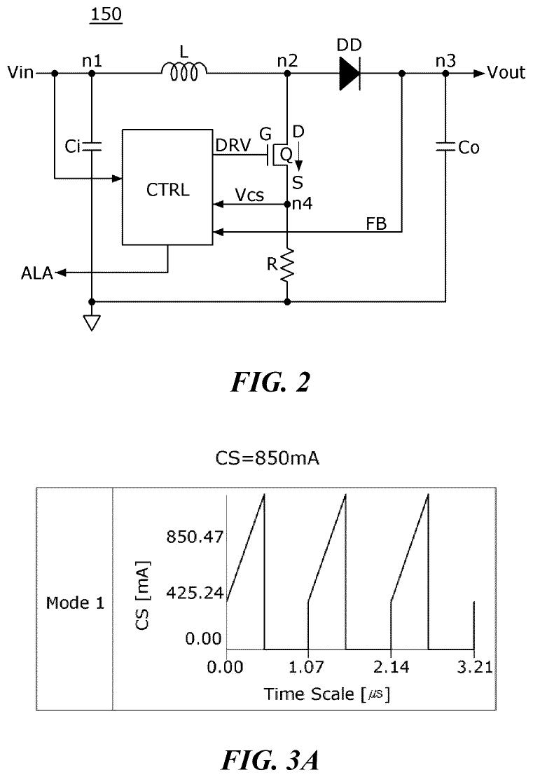

FIG. 2 is a circuit diagram showing a power circuit according to an embodiment of the present disclosure.

Referring to FIG. 2, the power circuit 150 includes an inductor L, a transistor Q, a diode DD, capacitors Ci and Co, a controller CTRL, and a resistor R.

The inductor L is connected between a first node n1 to which an input voltage Vin is applied and a second node n2 to store energy. When the transistor Q is in the on state, the current input through the first node n1 is stored in the magnetic field formed by the inductor L, and when transistor Q is turned off, the energy stored in the magnetic field of the inductor L is released so that the output voltage Vout may be boosted. The first capacitor Ci is connected between the first node and the GND node to remove ripple of the input voltage Vin and replenish energy to the inductor L with the charged voltage when the transistor Q is switched. Ground voltage GND is applied to the GND node.

The transistor Q is turned on/off under the control of the controller CTRL, which allows energy to be stored in the inductor L or to allow the energy stored in the inductor L to be output through the diode DD and the second capacitor Co. In FIG. 2, the arrow indicates the current flowing through the transistor Q. The transistor Q includes a gate electrode G connected to the controller CTRL, a first electrode D connected to the second node n2, and a second electrode S connected to a fourth node n4. The first electrode D and the second electrode S of the transistor Q may be a drain electrode and a source electrode, respectively.

The controller (CTRL) can control the gate voltage based on a switching current CS and a threshold determined based on the one or more of the input voltage or the output voltage. The threshold can be an OCP voltage level. The controller CTRL receives a feedback FB of the output voltage Vout from a third node n3 from which the output voltage Vout is output, and controls the gate voltage DRV of the transistor Q with a pulse-width modulation (PWM) signal when the feedback output voltage FB changes to suppress fluctuation of the output voltage Vout. For example, the controller CTRL may increase the duty ratio of the gate voltage DRV to increase the output voltage Vout when the output voltage Vout decreases, while decreasing the duty ratio of the gate voltage DRV to decrease the output voltage Vout when the output voltage Vout increases, but is not limited thereto. The controller CTRL adjusts the duty ratio of PWM that controls the gate voltage of the transistor Q according to the difference between the input voltage Vin and the feedback FB of the output voltage Vout, thereby adjusting the current flowing through the drain-source channel of the transistor Q (hereinafter referred to as “switching current”) CS to suppress fluctuation of the output current flowing to the third node n3.

The controller CTRL blocks the gate voltage DRV of the transistor Q so that the power circuit 150 does not operate when the voltage of the fourth node n4 through which the switching current CS flows becomes higher than the OCP voltage level, and then generates an alarm signal ALA. The alarm signal ALA may be applied to at least one of the host system 200 and the timing controller 130.

The host system 200 may stop the operation of the power circuit 150 by blocking the input voltage Vin of the power circuit 150 in response to the alarm signal ALA, and stop the operation of the display panel driving circuits 110 and 120 as well as the level shifter 140. In response to the alarm signal ALA, the timing controller 130 may stop the operation of the display panel driving circuits 110 and 120 and the level shifter 140 by stopping signal transmission to them or by transmitting a disable signal to them.

The controller CTRL adjusts the OCP voltage level to a voltage proportional to the switching current CS when at least one of the input voltage Vin and the output voltage Vout changes or when the output voltage Vout changes corresponding to the resolution and size of the display panel. As a result, the display device according to the embodiment may optimize OCP control corresponding to the driving method of the display panel and the resolution and size of the display panel.

The diode DD is connected between the second node n2 and the third node n3 to provide a current path so that current from the inductor L flows toward the third node n3 when the transistor Q is in the off state, and blocks reverse current. The diode DD includes an anode electrode connected to the second node and a cathode electrode connected to third node n3.

The second capacitor Co is connected between the third node n3 and the GND node to smooth the output voltage Vout delivered to the load and reduce ripple. The load may be the display panel driving circuits 110 and 112 and the pixels of display panel 100. The output voltage Vout may be a gate high voltage, but is not limited thereto.

The resistor R is connected between the fourth node n4 and the GND node. The resistor R enables the controller CTRL to sense the switching current CS and increases the sensitivity of current sensing.

In the embodiment, the OCP target level is adjusted to a voltage proportional to the switching current CS when one or more of the input voltage Vin and the output voltage Vout of the power circuit 150 changes within an allowed range in a predetermined driving mode.

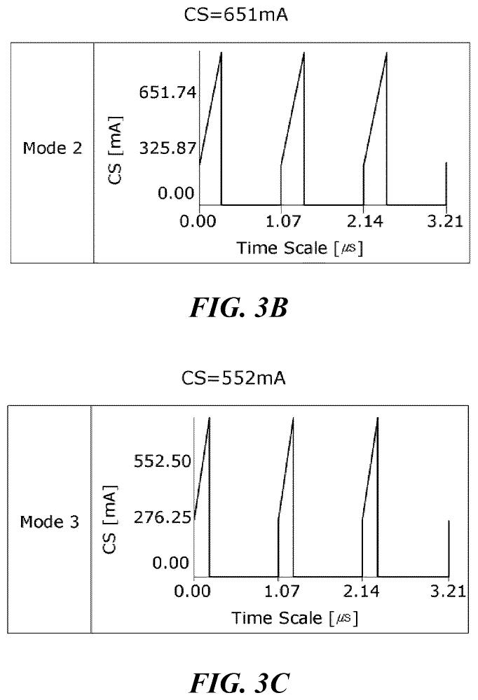

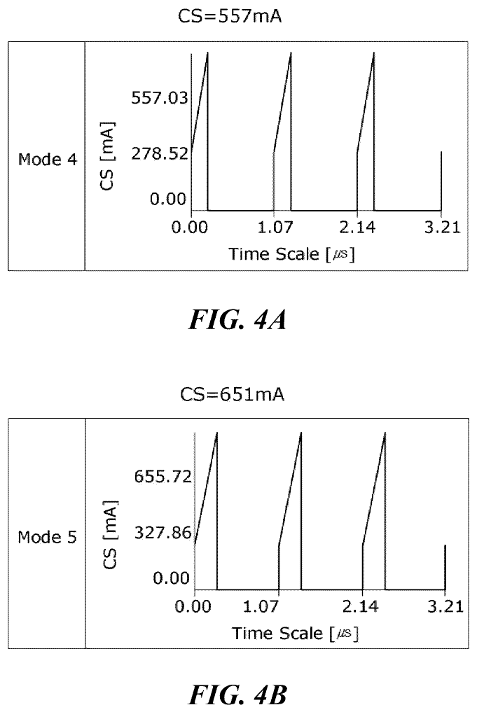

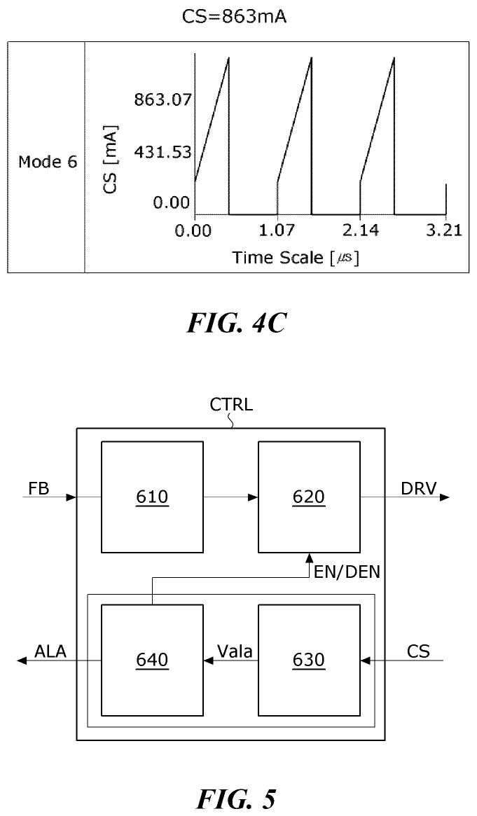

The switching current CS may vary depending on the difference between the input voltage Vin and the output voltage Vout. The OCP voltage level may be set to a value corresponding to an output current, for example, 300 [mA], in which the switching current CS is set in advance, as shown in FIGS. 3A to 4C, but is not limited thereto. The switching current CS may vary when one or more of input voltage Vin and output voltage Vout changes, and the OCP target level may be adjusted to a value proportional to the switching current CS.

FIGS. 3A to 3C are diagrams showing an example in which the switching current changes when the input voltage changes in the circuit shown in FIG. 2. In FIGS. 3A to 3C, the output voltage Vout is 22 [V], and the input voltage changes between 12 [V] and 18 [V]. When the input voltage Vin changes in this way, the switching current CS changes so that the output current may be maintained at 300 [mA]. The OCP voltage level may be adjusted in proportion to the switching current CS when the input voltage Vin changes. In FIGS. 3A to 3C, the horizontal axis represents time [μs] and the vertical axis represents the switching current [mA].

In FIG. 3A, a first mode Mode 1 may be a low power consumption mode. In the first mode Mode 1, the input voltage Vin and the output voltage Vout may be Vin=12 [V] and Vout=22 [V], respectively. In this case, the switching current CS may be approximately 850 [mA].

In FIG. 3B, a second mode Mode 2 may be a normal driving mode. In the second mode Mode 2, the input voltage Vin and the output voltage Vout may be Vin=16 [V] and Vout=22 [V], respectively. In this case, the switching current CS may be approximately 651 [mA].

In FIG. 3C, a third mode Mode 3 may be a high luminance mode in which the pixels emit light with high luminance. In the third mode Mode3, the input voltage Vin and the output voltage Vout may be Vin=18 [V] and Vout=22 [V], respectively. In this case, the switching current CS may be approximately 552 [mA].

In FIGS. 3A to 3C, when the input voltage Vin increases, the switching current CS decreases. The OCP voltage level is adjusted in proportion to the switching current CS that changes depending on the input voltage Vin.

FIGS. 4A to 4C are diagrams showing an example in which the switching current changes when the output voltage changes in the circuit shown in FIG. 2. In FIGS. 4A to 4C, the input voltage Vin is 16 [V] and the output voltage changes between 20 [V] and 27 [V], respectively. When the output voltage Vout changes in this way, the switching current CS changes so that the output current may be maintained at 300 [mA]. The OCP voltage level may be adjusted in proportion to switching current CS when the output voltage Vout changes. In FIGS. 4A to 4C, the horizontal axis represents time [μs] and the vertical axis represents the switching current [mA].

In FIG. 4A, a fourth mode Mode 4 may be a driving mode for a small-sized model in which the display panel 100 is a small-sized panel or a low-resolution panel. In the fourth mode Mode 4, the input voltage Vin and the output voltage Vout may be Vin=16 [V] and Vout=20 [V], respectively. In this case, the switching current CS may be approximately 557 [mA].

In FIG. 4B, a fifth mode Mode 5 may be a driving mode for a medium-sized model in which the display panel 100 is a medium-sized panel or a medium-resolution panel. In the fifth mode Mode 5, the input voltage Vin and the output voltage Vout may be Vin=16 [V], Vout=22 [V], respectively. In this case, the switching current CS may be approximately 651 [mA].

In FIG. 4C, a sixth mode Mode 6 may be a driving mode for a large-sized model in which the display panel 100 is a large-sized panel or a high-resolution panel. In the sixth mode Mode 6, the input voltage Vin and the output voltage Vout may be Vin=16 [V], Vout=27 [V]. In this case, the switching current CS may be approximately 863 [mA].

In FIGS. 4A to 4C, when the output voltage Vout increases, the switching current CS increases. The OCP voltage level is adjusted in proportion to the switching current CS that changes according to the output voltage Vout.

FIG. 5 is a block diagram schematically showing the configuration of the controller shown in FIG. 2.

Referring to FIG. 5, the controller CTRL includes a first sensing part 610, a PWM control part 620, a second sensing part 630, and an OCP control part 640.

The first sensing part 610 senses the feedback output voltage FB from the third node n3, which is an output node, and provides it to the PWM control part 620. The PWM control part 620 adjusts the duty ratio of the gate voltage DRV when the feedback output voltage FB fluctuates to control the switching current CS flowing through the transistor Q.

The second sensing part 630 generates an OCP voltage level IOCP based on at least one of the input voltage Vin and the output voltage Vout, and outputs an alarm voltage Vala at a set voltage level when the voltage of the fourth node n4 through which the switching current CS flows becomes higher than the OCP voltage level IOCP. The OCP control part 640 outputs an alarm signal ALA in response to the alarm voltage Vala, and disables the PWM control part 620 using an enable signal EN/DEN to stop the gate voltage output of the PWM control part 620. The OCP control part 640 may generate the enable signal EN/DEN that enables or disables the PWM control part 620. The PWM control part 620 is enabled when the enable signal EN/DEN has a first logic value and is disabled in response to the enable signal EN/DEN being a second logic value, which stops the operation.

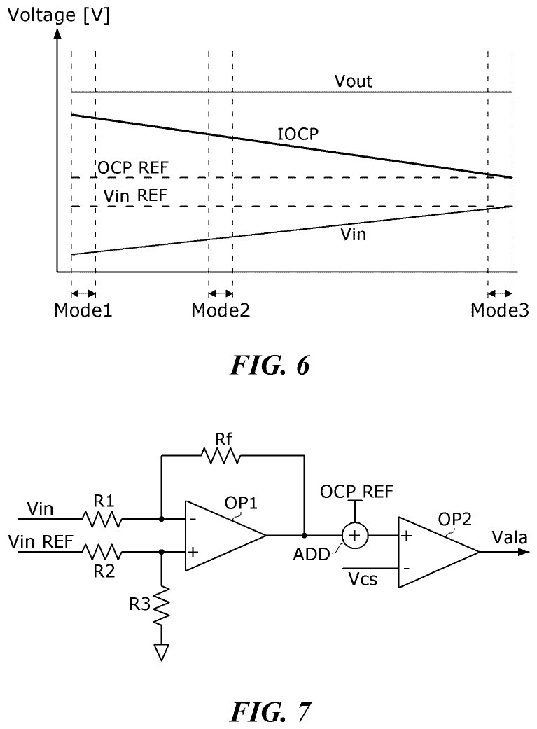

FIG. 6 is a diagram showing an example in which the OCP voltage level is adjusted when the input voltage changes.

Referring to FIGS. 3A to 3C and FIG. 6, the OCP voltage level IOCP is proportional to the switching current CS that changes depending on the input voltage Vin. The OCP voltage level IOCP is inversely proportional to the input voltage Vin. For example, when the input voltage Vin increases, the switching current CS and the OCP voltage level IOCP decrease. The OCP voltage level IOCP may be a second reference voltage.

The power circuit 150 generates the first reference voltage Vin REF and the OCP reference voltage OCP REF as constant voltages at different voltage levels. The first reference voltage Vin REF may be set within an adjustable range of the input voltage Vin. For example, the first reference voltage Vin REF may be set as the highest voltage within an adjustable range of the input voltage Vin, but is not limited thereto. The OCP reference voltage OCP REF is set within an adjustable range of the OCP voltage level IOCP. For example, the OCP reference voltage OCP REF may be set as the lowest voltage within an adjustable range of the OCP voltage level IOCP, but is not limited thereto.

FIG. 7 is a circuit diagram showing the second sensing part according to an embodiment of the present disclosure.

Referring to FIG. 7, the second sensing part 630 includes a subtractor (OP1, R1 to R3, and Rf), an adder ADD, and a comparator OP2.

The subtractor (OP1, R1 to R3, and Rf) includes a first operational amplifier OP1 and a plurality of resistors R1 to R3. A first resistor R1 is connected between the first node n1 to which the input voltage Vin is applied and the inverting input terminal (−) of the first operational amplifier OP1. A second resistor R2 is connected between the node to which the first reference voltage Vin REF is applied and the non-inverting input terminal (+) of the first operational amplifier OP1. A third resistor R3 is connected between the non-inverting input terminal (+) of the first operational amplifier OP1 and the GND node. A fourth resistor Rf is connected between the output terminal and the inverting input terminal (−) of the first operational amplifier OP1. The subtractor (OP1, R1 to R3, and Rf) amplifies the difference voltage between the input voltage Vin and the first reference voltage Vin REF and inputs it to the adder ADD.

The adder ADD adds the OCP reference voltage OCP REF to the output voltage of the subtractor (OP1, R1 to R3, and Rf) to output the OCP voltage level IOCP. The comparator OP2 compares the OCP voltage level IOCP with the voltage Vcs of the fourth node n4 through which the switching current CS flows, and outputs the alarm voltage Vala at a first voltage level when the voltage of the fourth node n4 is equal to or less than the OCP voltage level IOCP, while outputting the alarm voltage Vala at a second voltage level when the voltage of the fourth node n4 is higher than the OCP voltage level IOCP. The first voltage level may be a high voltage, and the second voltage level may be a low voltage lower than the first voltage level.

The OCP control part 640 receives the alarm voltage Vala from the comparator OP2, outputs the alarm signal ALA when the alarm voltage Vala is at the second voltage level, and disables the PWM control part 620.

FIG. 8 is a diagram showing an example in which the OCP voltage level is adjusted when the output voltage changes.

Referring to FIGS. 4A to 4C and FIG. 8, the OCP voltage level IOCP is proportional to the switching current CS that changes depending on the output voltage Vout. The OCP voltage level IOCP is proportional to the output voltage Vout. For example, when the output voltage Vout increases, the switching current CS and the OCP voltage level IOCP increase.

The power circuit 150 generates the first reference voltage Vout REF and the OCP reference voltage OCP REF as constant voltages at different voltage levels. The first reference voltage Vout REF may be set within the adjustable range of the output voltage Vout. For example, the first reference voltage Vout REF may be set as the lowest voltage within the adjustable range of the output voltage Vout, but is not limited thereto. The OCP reference voltage OCP REF is set within the adjustable range of the OCP voltage level IOCP. For example, the OCP reference voltage OCP REF may be set as the lowest voltage within the adjustable range of the OCP voltage level IOCP, but is not limited thereto. The OCP voltage level IOCP may be the second reference voltage.

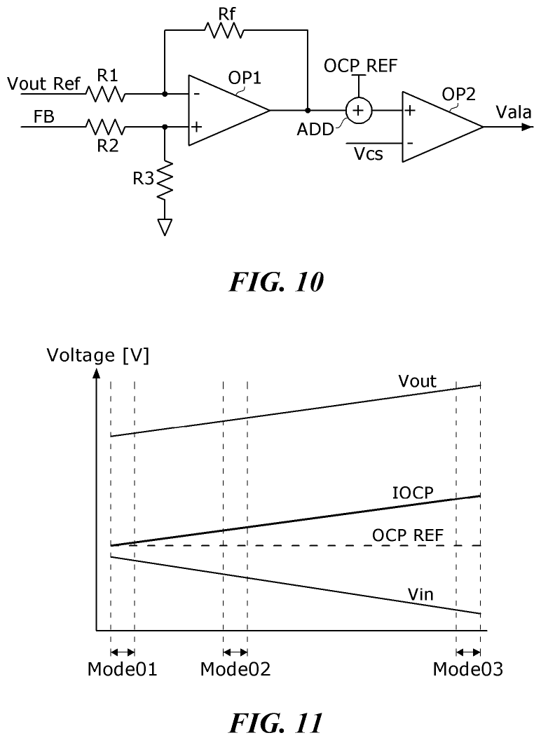

FIG. 9 is a circuit diagram showing a power circuit according to another embodiment of the present disclosure. FIG. 10 is a circuit diagram showing a second sensing part applicable to the power circuit shown in FIG. 9. In this embodiment, descriptions overlapping with the above-described embodiment may be omitted.

Referring to FIGS. 5, 9, and 10, the controller CTRL of the power circuit 150 controls the gate voltage DRV of the transistor Q with a pulse width modulation (PWM) signal when the feedback output voltage FB from the third node n3 changes to suppress fluctuation of the output voltage Vout. The controller CTRL generates the OCP voltage level IOCP by adding the OCP reference voltage OCR REF to the difference voltage between the feedback output voltage FB and the first reference voltage Vout REF. The controller CTRL outputs the alarm signal ALA when the voltage of the fourth node n4 through which the switching current CS flows is greater than the OCP voltage level OCP REF. The controller CTRL includes the first sensing part 610, the PWM control part 620, the second sensing part 630, and the OCP control part 640 as shown in FIG. 5.

The second sensing part 630 generates the OCP voltage level IOCP based on the difference voltage between the feedback output voltage FB and the first reference voltage Vout REF, and outputs the alarm voltage Vala at a specific voltage level when the voltage Vcs of the fourth node n4 through which the switching current CS flows becomes higher than the OCP voltage level IOCP.

The second sensing part 630 includes the subtractor (OP1, R1 to R3, and Rf), the adder ADD, and the comparator OP2.

The subtractor (OP1, R1 to R3, and Rf) amplifies the difference voltage between the feedback output voltage FB and the first reference voltage Vout REF and inputs it to the adder ADD. The adder ADD adds the OCP reference voltage OCP REF to the output voltage of the subtractor (OP1, R1 and R3, and Rf) to output the OCP voltage level IOCP. The comparator OP2 compares the OCP voltage level IOCP with the voltage of the fourth node n4 through which the switching current CS flows, and outputs the alarm voltage Vala at a first voltage level when the voltage of the fourth node n4 is equal to or less than the OCP voltage level IOCP, while outputting the alarm voltage Vala at a second voltage level when the voltage of the fourth node n4 is higher than OCP voltage level IOCP. The OCP control part 640 receives the alarm voltage Vala from the comparator OP2, outputs the alarm signal ALA when the alarm voltage Vala is at the second voltage level, and disables the PWM control part 620.

FIG. 11 is a diagram showing an example in which the OCP voltage level is adjusted when the input voltage and the output voltage change.

Referring to FIG. 11, the OCP voltage level IOCP is proportional to the switching current CS that changes depending on the difference between the input voltage Vin and the output voltage Vout. The OCP voltage level IOCP is proportional to the output voltage Vout and inversely proportional to the input voltage Vin. For example, when the difference between the input voltage Vin and the output voltage Vout increases, the switching current CS and the OCP voltage level IOCP increase.

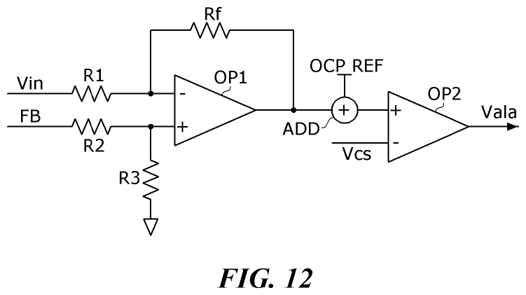

FIG. 12 is a circuit diagram showing the circuit configuration of the second sensing part for controlling the OCP based on the difference between the input voltage and the output voltage. In this embodiment, descriptions overlapping with the above-described embodiment may be omitted.

Referring to FIGS. 2 and 12, the controller CTRL of the power circuit 150 receives the feedback output voltage and controls the gate voltage DRV of the transistor Q with a pulse width modulation (PWM) signal to suppress fluctuation of the output voltage Vout. The controller CTRL generates the OCP voltage level IOCP by adding the OCP reference voltage OCR REF to the difference voltage between the input voltage Vin and the feedback FB of the output voltage Vout (or feedback voltage). The controller CTRL outputs the alarm signal ALA when the voltage of the fourth node n4 through which the switching current CS flows is greater than the OCP voltage level OCP REF. The controller CTRL includes the first sensing part 610, the PWM control part 620, the second sensing part 630, and the OCP control part 640 as shown in FIG. 5.

The second sensing part 630 includes the subtractor (OP1, R1 to R3, and Rf), the adder ADD, and the comparator OP2.

The subtractor (OP1, R1 to R3, and Rf) amplifies the difference voltage between the input voltage Vin and the feedback output voltage FB and inputs it to the adder ADD. The adder ADD adds the OCP reference voltage OCP REF to the output voltage of the subtractor (OP1, R1 to R3, and Rf) to output the OCP voltage level IOCP. The comparator OP2 compares the OCP voltage level IOCP with the voltage of the fourth node n4 through which the switching current CS flows, and outputs the alarm voltage Vala at a first voltage level when the voltage of the fourth node n4 is lower than OCP voltage level IOCP, while outputting the alarm voltage Vala at a second voltage level when the voltage of the fourth node n4 is higher than the OCP voltage level IOCP.

In the description herein, some example voltage or current values are mentioned for descriptive purposes. It should be appreciated that implementations of the disclosure may use different voltage or current values which are also included in the scope of the disclosure. For example, in the example implementations shown in FIGS. 7, 10, and 12, the input voltage Vin may be replaced with another voltage value that represents the input voltage, e.g., another voltage that is proportional to the input voltage; the feedback output voltage FB may be replaced by another voltage value that represents the output voltage Vout, e.g., another voltage that is proportional to the output voltage; and the reference voltage values Vout REF, Vin REF, or the OCT REF may also be adjusted accordingly.

According to one or more embodiments of the present disclosure, the display apparatus may be applied to mobile apparatuses, video phones, smart watches, watch phones, wearable apparatus, foldable apparatus, rollable apparatus, bendable apparatus, flexible apparatus, curved apparatus, sliding apparatus, variable apparatus, electronic organizer, electronic books, portable multimedia players (PMPs), personal digital assistants (PDAs), MP3 players, mobile medical apparatuses, desktop PCs, laptop PCs, netbook computers, workstations, navigations, vehicle navigations, vehicle display apparatuses, vehicle apparatuses, theater apparatuses, theater display apparatuses, televisions, wallpaper apparatuses, signage apparatuses, game apparatuses, laptops, monitors, cameras, camcorders, and home appliances, etc. Additionally, the display apparatus according to one or more embodiments of the present disclosure may be applied to organic light emitting lighting apparatuses or inorganic light emitting lighting apparatuses.

The features to be achieved by the present disclosure, the means for achieving the features, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A power circuit comprising:
a first node configured to receive an input voltage;
an inductor connected between the first node and a second node;
a third node configured to output an output voltage;
a diode connected between the second node and the third node;
a transistor connected between the second node and a fourth node, the transistor is configured to generate a switching current according to a gate voltage; and
a controller connected to the fourth node, the controller is configured to stop driving of the transistor and output an alarm signal based on an overcurrent protection voltage and the switching current.

2. The power circuit of claim 1, further comprising:
a resistor connected between the fourth node and a ground voltage node.

3. The power circuit of claim 1, wherein the controller comprises:
a first sensing part configured to sense a feedback output voltage from the third node;
a PWM control part configured to adjust a duty ratio of the gate voltage when the feedback output voltage fluctuates;
a second sensing part configured to generate the overcurrent protection voltage based on at least one of the input voltage or the output voltage and to output an alarm voltage when a voltage of the fourth node is higher than the overcurrent protection voltage; and
an OCP control part configured to output the alarm signal in response to the alarm voltage and to stop outputting the gate voltage from the PWM control part.

4. The power circuit of claim 3, wherein when the input voltage increases, the switching current and the overcurrent protection voltage decrease.

5. The power circuit of claim 3, wherein the power circuit is configured to generate a first reference voltage and a second reference voltage, and
wherein:
the first reference voltage and the second reference voltage are generated as constant voltages at different voltage levels,
the first reference voltage is set as a highest voltage within an adjustable range of the input voltage, and
the second reference voltage is set as a lowest voltage within an adjustable range of the overcurrent protection voltage.

6. The power circuit of claim 5, wherein the second sensing part comprises:
a subtractor configured to amplify a difference voltage between the input voltage and the first reference voltage;
an adder configured to add the second reference voltage to an output voltage of the subtractor to output the overcurrent protection voltage; and
a comparator configured to output the alarm voltage when the voltage of the fourth node is higher than the overcurrent protection voltage.

7. The power circuit of claim 3, wherein when the output voltage increases, the switching current and the overcurrent protection voltage increase.

8. The power circuit of claim 7, wherein the power circuit is configured to generate a first reference voltage and a second reference voltage, and
wherein:
the first reference voltage and the second reference voltage are generated as constant voltages at different voltage levels,
the first reference voltage is set as a lowest voltage within an adjustable range of the output voltage, and
the second reference voltage is set as a lowest voltage within an adjustable range of the overcurrent protection voltage.

9. The power circuit of claim 8, wherein the second sensing part comprises:
a subtractor configured to amplify a difference voltage between the feedback output voltage and the first reference voltage;
an adder configured to add the second reference voltage to an output voltage of the subtractor to output the overcurrent protection voltage; and
a comparator configured to output the alarm voltage when the voltage of the fourth node is higher than the overcurrent protection voltage.

10. The power circuit of claim 3, wherein when a difference between the input voltage and the output voltage increases, the switching current and the overcurrent protection voltage increase.

11. The power circuit of claim 10, wherein the power circuit is configured to generate
a reference voltage, and
the reference voltage is set as a lowest voltage within an adjustable range of the overcurrent protection voltage.

12. The power circuit of claim 11, wherein the second sensing part comprises:
a subtractor configured to amplify a difference voltage between the input voltage and the feedback output voltage;
an adder configured to add the reference voltage to an output voltage of the subtractor to output the overcurrent protection voltage; and
a comparator configured to output the alarm voltage when the voltage of the fourth node is higher than the overcurrent protection voltage.

13. A display device comprising:
a display panel having a plurality of data lines, a plurality of gate lines, and a plurality of pixels disposed on the display panel;
a display panel driving circuit configured to write data to the pixels; and
a power circuit configured to output voltages necessary for driving the display panel and the display panel driving circuit,
wherein the power circuit comprises:
a first node configured to receive an input voltage;
an inductor connected between the first node and a second node;
a third node configured to output an output voltage;
a diode connected between the second node and the third node;
a transistor connected between the second node and a fourth node, the transistor is configured to generate a switching current according to a gate voltage; and
a controller connected to the fourth node, the controller is configured to stop driving of the transistor and output an alarm signal based on an overcurrent protection voltage and the switching current.

14. The display device of claim 13, wherein the power circuit further comprises:
a resistor connected between the fourth node and a ground voltage node.

15. The display device of claim 13, wherein the controller comprises:
a first sensing part configured to sense a feedback output voltage from the third node;
a PWM control part configured to adjust a duty ratio of the gate voltage when the feedback output voltage fluctuates;
a second sensing part configured to generate the overcurrent protection voltage based on at least one of the input voltage or the output voltage and to output an alarm voltage when a voltage of the fourth node is higher than the overcurrent protection voltage; and
an OCP control part configured to output the alarm signal in response to the alarm voltage and to stop outputting the gate voltage output of the PWM control part.

16. The display device of claim 15, wherein when the input voltage increases, the switching current and the overcurrent protection voltage decrease.

17. The display device of claim 15, wherein when the output voltage increases, the switching current and the overcurrent protection voltage increase.

18. The display device of claim 15, wherein when a difference between the input voltage and the output voltage increases, the switching current and the overcurrent protection voltage increase.

19. A power circuit comprising:
a first node configured to receive an input voltage;
an inductor connected between the first node and a second node;
a third node configured to output an output voltage;
a diode connected between the second node and the third node;
a transistor connected between the second node and a fourth node, the transistor is configured to generate a switching current according to a gate voltage; and
a controller configured to control the gate voltage based on the switching current and a threshold determined based on the one or more of the input voltage or the output voltage.

20. The power circuit of claim 19, wherein the power circuit includes:
a subtractor;
an adder configured to add an output of the subtractor and a first reference value; and
a comparator configured to compare an output of the adder with a voltage at the fourth node,
wherein the subtractor is configured to receive two signals of a first signal representing the input voltage, a second signal representing the output voltage, or a reference signal.
